(19) United States
(12) Patent Application Publication
(10) Pub. No.: US 2006/0019015 A1
(43) Pub. Date: Jan. 26, 2006

(54) Runny chocolate souffle dessert

(76) Inventor: Alberto Faks, Brooklyn, NY (US)

Correspondence Address: Ezra Sutton, Esq., Plaza 9 Building, 900 Route 9, Woodbridge, NJ, 07095, US

(21) Appl. No.: 11/206,631

(22) Filed: Oct. 3, 2005

Related U.S. Application Data
(63) Continuation of application No. 10/342,789, filed on Jan. 15, 2003, now abandoned.

(51) Int. Cl. A21D 13/04

(52) U.S. Cl. 426/558

(57) ABSTRACT

A process for making a flavored souffle dessert product, including the following steps: Mixing and kneading of eggs, sugar, margarine/butter, flour, baking soda, salt and cocoa in a first mixing hopper to form a cookie dough; proofing the cookie dough in a proofing refrigerator at a temperature between 35° and 45° F. for a time period of at least 24 hours; stirring of a flavoring ingredient, corn syrup, vegetable oil, starch and water in a second mixing hopper to form a flavored paste filling; gelling of the flavored paste filling in a refrigerator at a temperature of 50° F. for a time period of at least 12 hours; encrusting an amount of the cookie dough about an amount of the flavored paste filling using an encrusting and extrusion machine; extruding the encrusted cookie dough and the flavored paste filling using the encrusting and extrusion machine for forming a flavored souffle dessert product and the dessert product having a weight in the range of 160 to 200 grams per, inserting the dessert products into a silicone molded cookie tray having a plurality of cavities therein; baking the dessert products within the plurality of cavities of the cookie tray in an oven at a temperature of at least 350° F. for a time period of at least 30 minutes; freezing the dessert products on a cooling rack within the plurality of cavities of the cookie tray in a freezer unit at a temperature of at least −20° F. for a time period of at least 45 minnutes; removing the frozen dessert products from the plurality of cavities of the cookie tray to a conveyor belt; and placing the frozen dessert products in a shipping container for shipment to consumers.

### FIELD OF THE INVENTION

This invention relates to a method of manufacturing a runny chocolate souffle dessert product. More particularly, this method includes the encrusting of a cookie dough about a chocolate paste filling to form the souffle dessert product, and heating of the product just before eating it. In this manner, during eating of the product, the runny chocolate filling exudes from the interior making the product enjoyable and delicious to eat.

### BACKGROUND OF THE INVENTION

Baked dessert products are an important food choice for most consumers having key nutritional value for the user. The consumer demand for baked dessert products over the years has increased dramatically due to the ease of use, convenience, and availability of such baked dessert products. Many bakery and food producing companies are baking and freezing their baked dessert products and then shipping them to smaller stores, specialty bake stores, grocery stores, delicatessens, restaurants, supermarkets and the like. Further, individuals, families, catering companies, restaurants, company cafeterias, and fast food chains are requesting baked dessert products, which can be prepared with minimum preparation time by the user. But, at the same time, the user/consumer wants a high-quality dessert product having an above-average shelf life, as compared to standard types of baked dessert products.

This desire for a quality baked dessert product with minimal preparation time (further baking at the user level) has led to the widespread utilization of microwave ovens, as well as convection-type ovens to reheat and bake the dessert product for immediate consumption. While microwave energy will rapidly heat most food products, not all microwave-heated dessert products are able to deliver the same quality of product, as is characteristic of the more traditional conduction oven heated dessert products. This lack of quality is quite prevalent in the area of microwave heated dessert products. Dessert products that have been exposed to excessive microwave irradiation have an increased toughness and a rubber-like or leather-like texture.

There remains a need for a flavored souffle desert product that has a high quality and palatability (palatability refers to the mouth feel, and taste quality of the dessert product) after short exposure of time when rebaking/reheating of the dessert products using a microwave oven or a convection-type oven for a minimal amount of time. Additionally, the flavored souffle dessert product will have an above average, extended shelf-life of at least 3 months. The flavored souffle dessert product after reheating/rebaking will have an outer crisper cookie texture about an expanded flavored souffle inner filling. Further, the method of manufacturing the flavored souffle dessert is novel and unique with regard to the steps of inserting the dessert into a silicone molded baking tray, the freezing of the dessert products after a partial baking and the removing of the dessert products from the silicone baking tray.

### DESCRIPTION OF THE PRIOR ART

Baked dessert products and method of manufacturing baked dessert products having various process methods have been disclosed in the prior art. For example, U.S. Pat. No. 4,948,602 discloses a baked cookie having a two phase interior filling. There is an oil based interior filling and a water based interior filling. The oil based interior filling coats at least part of the interior of the biscuit and enhances the taste of the cookie. Upon this cookie being heated in a microwave oven the water based filling expands and exudes out through the top of the cookie flowing down the exterior surfaces and coating these surfaces. This cookie is produced by co-extruding the dough and the oil based filling. The dough piece is then baked whereby there is formed a hollow interior section. The hollow interior section is then filled with the water based filling. This prior art patent does not teach or disclose the process for manufacturing of a flavored souffle dessert product of the present invention.

U.S. patent Publication No. US2002/0136797A1 discloses a ready to eat filled bagel dough product that can be produced by a method comprising preparing a bagel dough; sealing a quantity of filling material within a quantity of bagel dough to form a shaped, filled bagel dough product; adding topping to the shaped product; proofing the shaped product, and then (1) chilling or freezing the proofed, shaped product to reduce the filler core temperature, steaming the product for an amount of time sufficient to completely cook the dough, freezing the product for long term storage, and subsequently thawing and/or reheating in a microwave oven prior to consumption; or (2) chilling or freezing the proofed, shaped product to reduce the filler core temperature, steaming the product for an amount of time sufficient to completely cook the dough, again chilling the product to reduce the temperature of the filler, baking or browning the product, freezing the product for long term storage, and subsequently thawing and/or reheating in a microwave oven prior to consumption. This prior art patent publication foes not teach or disclose the process for manufacturing of a flavored souffle dessert product of the present invention.

None of the prior art references disclose the particular manufacturing process for making a flavored souffle dessert product of the present invention having novel and unique extruding, baking, freezing, and removal steps thereof.

Accordingly, it is an object of the present invention to provide a flavored souffle dessert product (i.e. chocolate) that has a high quality and palatability after rebaking or reheating of the dessert product using a microwave oven or a convection-type oven for a minimal amount of time.

Another object of the present invention is to provide a chocolate souffle dessert that has an above average, extended shelf-life of at least three (3) months.

Another object of the present invention is to provide a chocolate souffle dessert product that has an outer crisper cookie-like texture about an expanded chocolate souffle filling after reheating or rebaking.

Another object of the present invention is to provide a chocolate souffle dessert product having a novel and unique method of manufacturing with regard to the steps of inserting the plurality of dessert products into a plurality of baking cavities of a silicone baking tray, freezing of the plurality of dessert products within each of the plurality of baking cavities of the silicone molded baking tray after a partial baking of the dessert products and removing of the frozen dessert products from each of the baking cavities of the molded baking tray.

Another object of the present invention is to provide a chocolate souffle dessert product that can be mass produced in an automated and economical manner and is reasonably affordable by the user.

### SUMMARY OF THE INVENTION

In accordance the present invention, there is provided a process for making a flavored souffle dessert product, including the following steps: Mixing and kneading of eggs, sugar, margarine/butter, flour, baking soda, salt and cocoa in a first mixing hopper to form a cookie dough; proofing the cookie dough in a proofing refrigerator at a temperature between 35° and 45° F. for a time period of at least 24 hours; stirring of a flavoring ingredient, corn syrup, vegetable oil, starch and water in a second mixing hopper to form a flavored paste filling; gelling of the flavored paste filling in a refrigerator at a temperature of 50° F. for a time period of at least 12 hours; encrusting an amount of the cookie dough about an amount of the flavored paste filling using an encrusting and extrusion machine; extruding the encrusted cookie dough and the flavored paste filling using the encrusting and extrusion machine for forming a flavored souffle dessert product and the dessert product having a weight in the range of 160 to 200 grams per; inserting the dessert products into a silicone molded cookie tray having a plurality of cavities therein; baking the dessert products within the plurality of cavities of the cookie tray in an oven at a temperature of at least 350° F. for a time period of at least 30 minutes; freezing the dessert products on a cooling rack within the plurality of cavities of the cookie tray in a freezer unit at a temperature of at least −20° F. for a time period of at least 45 minutes; removing the frozen dessert products from the plurality of cavities of the cookie tray to a conveyor belt; and placing the frozen dessert products in a shipping container for shipment to consumers.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a perspective view of the chocolate souffle dessert product of the preferred embodiment of the present invention showing the frozen dessert product prior to final baking;

FIG. 2 is an elevational view of the chocolate souffle dessert products of the present invention taken along lines 2-2 of FIG. 1 in the direction of the arrows showing a cookie dough enclosing a chocolate paste filling of the frozen dessert product prior to the final baking;

FIG. 3 is a perspective view of the chocolate souffle dessert product of the present invention showing the baked dessert product after final baking by a consumer;

FIG. 4 is a perspective view of the chocolate souffle dessert product of the present invention taken along lined 4-4 of FIG. 3 in the direction of the arrows showing an encrusted cookie dough about an expanded chocolate souffle filling of the baked dessert product after final baking by a consumer;

FIG. 5 is a process flow chart illustrating the present invention showing the method of food processing including the major component equipment involved in the manufacture of a runny chocolate souffle dessert product for the steps of mixing; stirring; encrusting; extruding; inserting; baking; freezing; removing and placing; and

FIG. 6 is a process flow chart illustrating the present invention showing the steps of shipping, rebaking or reheating of the chocolate souffle dessert product.

### DETAILED DESCRIPTION OF THE PREFERRED EMBODIMENT

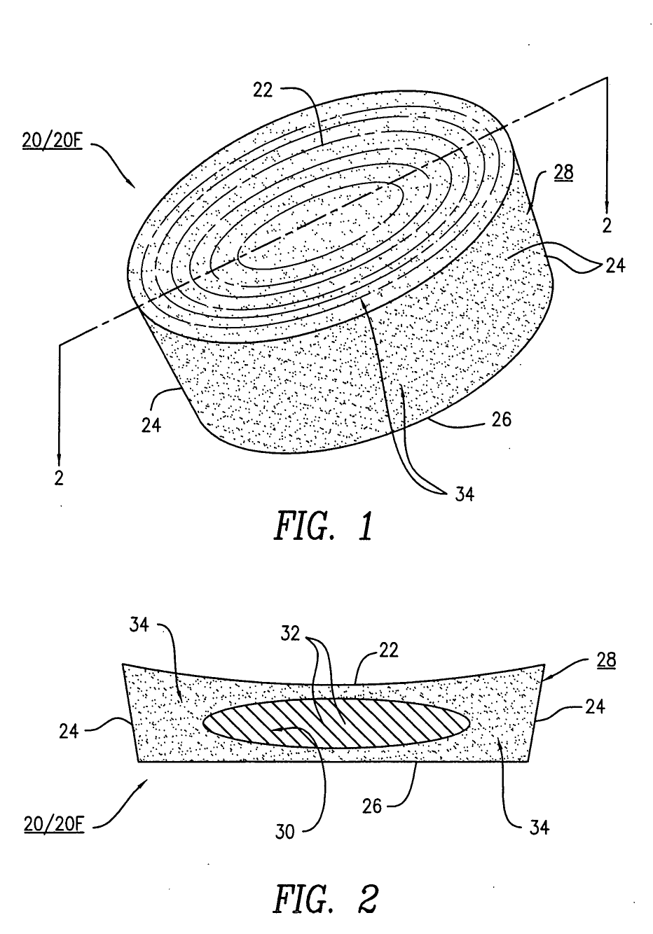

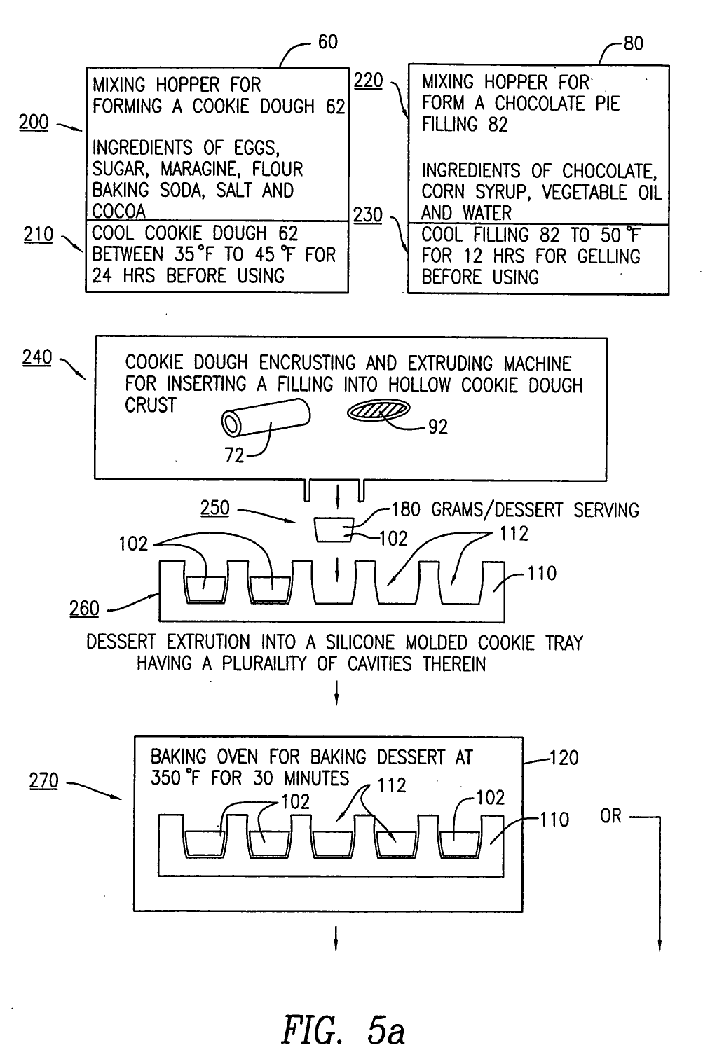

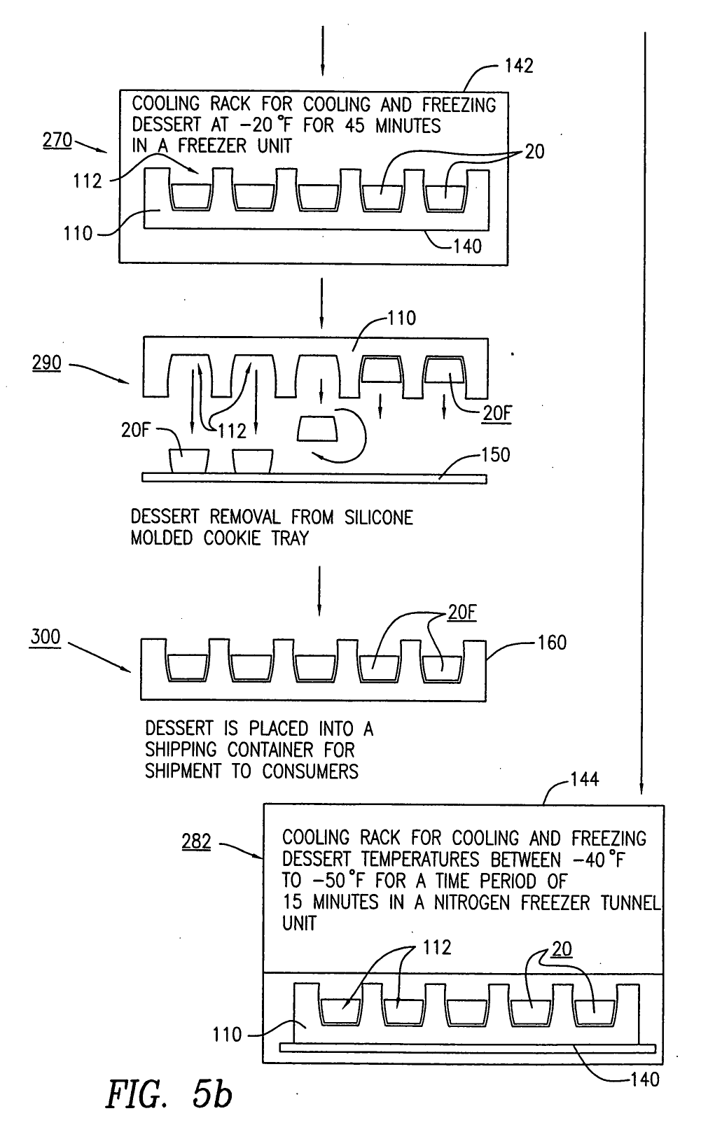

The method 10 of manufacturing a runny chocolate souffle dessert product 20 of the preferred embodiment of the present invention is represented in detail by FIGS. 1 through 5 of the patent drawings. The method 10 of manufacturing the runny chocolate souffle dessert product 20/20F, is shown in FIG. 5 of the drawing and includes the following process steps of mixing and kneading 200; proofing 210; stirring 220; gelling 230; encrusting 240; extruding 250; inserting 260; baking 270; freezing 280; removing 290; and placing and shipping 300. All of the processing steps 200, 210, 220, 230, 240, 250, 260, 270, 280, 290 and 300 are automated with the use of the appropriate food processing equipment, as shown in FIG. 5.

As shown in FIGS. 1 and 2, the completed runny chocolate souffle dessert product 20 or 20F is shown after the step 270 of partial baking or after the step 280 of freezing. The dessert product 20 or 20F includes a concave top 22, tapered circular sides 24 and a flat bottom 26 being substantially cylindrically-shaped 28 having a hollow interior cavity 30 for retaining a chocolate paste filling 32 therein. The chocolate paste filling 32 is encircled/enclosed by a cookie dough crust 34 being partially baked in the step 270 of partial baking.

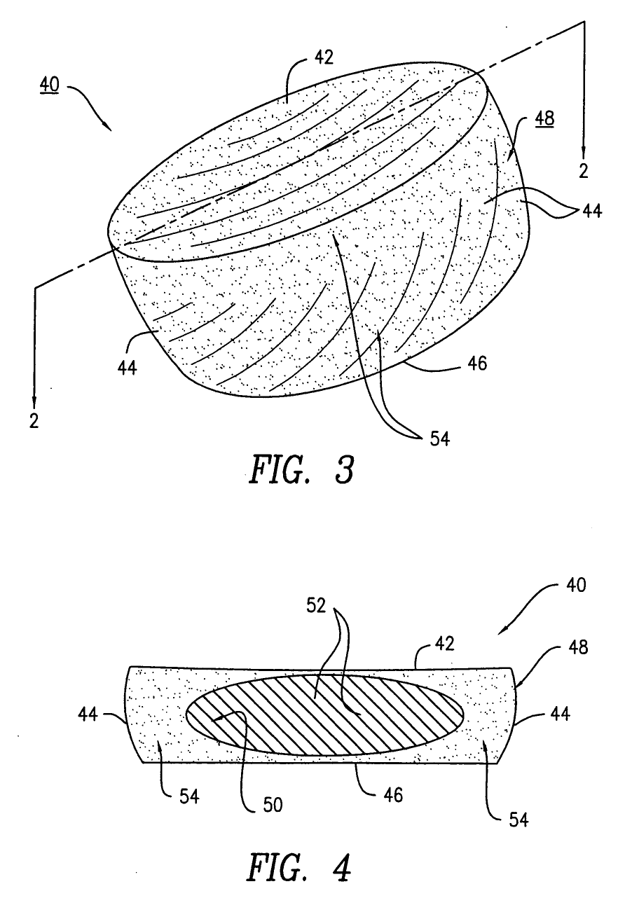

As shown in FIGS. 3 and 4, the runny chocolate souffle dessert product is shown after the step of rebaking 310 or the step of reheating 320. The rebaked chocolate souffle dessert product 40 includes a slightly concave top 42, tapered circular sides 44 and a flat bottom 46 being also substantially cylindrically-shaped 48 having a hollow interior cavity 50 for retaining the expanded chocolate souffle filling 52 therein. The expanded chocolate souffle filling 52 is enclosed by the rebaked cookie dough crust 54 being fully baked in the step 310 of rebaking or in the step of 320 of reheating.

The manufacturing process 10 for making a flavored souffle dessert product (i.e. a runny chocolate souffle dessert product 20), as depicted in the process flow diagram of FIG. 5, starts with the step of mixing and kneading 200, wherein an operator combines the ingredients of eggs, sugar, margarine/butter, flour, baking soda, salt and cocoa in a first mixing hopper 60 to mix and knead the aforementioned ingredients to form a cookie dough 62.

In the step of proofing 210, the cookie dough 62 is then transferred by the operator to a proofing refrigerator 70 in order to allow the cookie dough to “set up” in this step of proofing 210. The proofed cookie dough 72 is then refrigerated and proofed at a temperature of 35° F. to 45° F. for a time period of at least 24 hours.

Next, the operator proceeds to the step of stirring and mixing 220, such the operator combines the ingredients of a flavoring (e.g. chocolate), corn syrup, vegetable oil, starch and water in a second mixing hopper 80 in order to stir and mix the aforementioned ingredients to form a flavored paste filling 82. The flavored paste filling 82 is selected from a group consisting of chocolate, vanilla, lemon, orange, lime, strawberry, raspberry, custard, peach compote, apple compote, and combinations thereof.

In the step of gelling 230, the flavored paste filling 82 is then transferred by the operator to a refrigerator unit 90 in order to allow the flavored paste filling to gelatinize for better extruding properties in this step of gelling 230. The gelled flavored paste filling 92 is refrigerated in the refrigerator unit 90 to a temperature of at least 50° F. for a time period of at least 12 hours.

In the step of encrusting 240, the operator now proceeds to connect the first mixing hopper 60 having the proofed cookie dough 72 therein and connect to the second mixing hopper 80 having the gelled flavored paste filling 92 therein to an encrusting and extrusion machine 100 in the step of encrusting 240. The step of encrusting 240 includes the enclosing of a predetermined amount of proofed cookie dough 72 about a predetermined amount of gelled flavored paste filling 92. The predetermined amount of proofed cookie dough 72 is in the range of 120 grams to 140 grams and the predetermined amount of gelled flavored paste filling 92 is in the range of 40 grams to 80 grams.

In the step of extruding 250, the encrusting and extrusion machine 100 proceeds automatically to extrude the predetermined amount of proofed cookie dough 72 about the predetermined amount of gelled flavored paste filling 92 to form a flavored souffle dessert product (pre-baking) 102 in the step of extruding 250, as shown in FIG. 5. Each of the extruded flavored souffle dessert products 102 has a weight in the range of 160 grams to 200 grams per individual serving. During the step of inserting 260, each of the extruded flavored souffle dessert products 102 are then automatically inserted into a silicone molded cookie or muffin baking tray 110 having a plurality of cavities 112 therein. Each of the cavities 112 of the cookie/baking tray 110 receives an individual/single extruded flavored souffle dessert product 102 that is further molded into a substantially cylindrically shaped souffle dessert product 28, as depicted in FIGS. 1 and 2.

In the step of baking 270, the operator now proceeds to transfer the plurality of the molded flavored souffle dessert products 20 within the plurality of cavities 12 of (several) baking trays 110 to a baking oven 120 for the partial baking of the souffle dessert product 20 in this step of baking 270. The flavored souffle dessert products 20 are baked in the bakery oven 120 at a temperature of at least 350° F. for a time period of at least 30 minutes.

In the step of freezing 280, the operator then proceeds to immediately transfer the partially baked flavored souffle dessert products 20 within the plurality of cavities 112 of baking tray 110 to cooling racks 140 within a freezer unit 142 for the quick freezing of the partially baked dessert products 20 in this step of freezing 280, as depicted in FIG. 5. The partially baked dessert products 20 are frozen in the freezer unit 140 at a temperature of at least −20° F. for a time period of at least 45 minutes for forming a frozen flavored souffle dessert product 20F. In an alternate step of freezing 282, the partially baked dessert products 20 are frozen in a nitrogen freezing tunnel unit 144 at a temperature between −40° F. to −50° F. for a time period of at least 15 minutes for producing a plurality of frozen flavored souffle dessert products 20F.

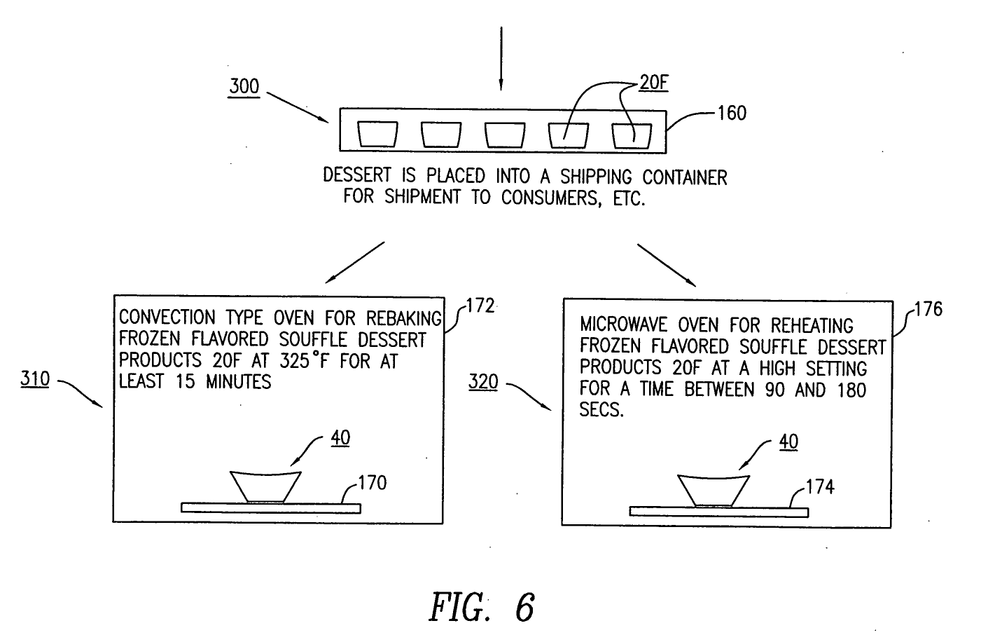

In the step of removing 290, the operator now removes the frozen flavored souffle dessert products 20F from each of the cavities 112 of the silicone molded baking tray 110 to a moving food conveyor belt 150 in this step of removing 290. A predetermined number of the frozen flavored souffle dessert products 20F are removed from the food conveyor belt 150 and are then placed into a shipping container 160 for shipment to the user, as shown in FIGS. 5 and 6, in this step of placing and shipping 300. The ultimate user, such as an individual, families, catering companies, restaurants, company cafeterias, fast food chains, bake stores, grocery stores, delicatessens and the like, then take the frozen souffle dessert product(s) 20F from their freezer and reheat or rebake the frozen flavored souffle dessert product(s) 20F for immediate consumption.

In the step of rebaking 310, the user now places the one or more frozen flavored souffle dessert products 20F on a flat cookie tray 170 and places the flat cookie tray 170 in a convection-type oven 172 for rebaking of the frozen flavored souffle dessert products 20F in this step of rebaking 310, as shown in FIG. 6. The frozen flavored souffle dessert products 20F are rebaked in the convection-type oven 172 at a temperature of at least 325° F. for a time period of at least 15 minutes for forming the baked flavored (chocolate) souffle dessert product(s) 40, as shown in FIGS. 3, 4 and 6 of the drawings. Alternately, in the step of reheating 320 the user can now place one or more of the frozen flavored souffle dessert products 20F on a flat microwave tray 174 and then place the flat microwave tray 174 in a microwave oven 176 for reheating of the frozen flavored souffle dessert product 20F in this step of reheating 320, as shown in FIG. 6. The frozen flavored souffle dessert product(s) 20F are reheated in the microwave oven 176 at a high setting for a period of time between 90 seconds and 180 seconds.

### ADVANTAGES OF THE PRESENT INVENTION

Accordingly, an advantage of the present invention is that it provides for a flavored souffle dessert product that has a high quality and palatability after rebaking or reheating of the dessert product using a microwave oven or a convection-type oven for a minimal amount of time.

Another advantage of the present invention is that it provides for a flavored souffle dessert that has an above average, extended shelf-life of at least three (3) months.

Another advantage of the present invention is that is provides for a flavored souffle dessert product that has an outer crisper cookie-like texture about an expanded flavored souffle inner filling after reheating or rebaking.

Another advantage of the present invention is that it provides for a flavored souffle dessert product having a novel and unique method of manufacturing with regard to the steps of inserting the plurality of dessert products into a plurality of baking cavities of a silicone molded baking tray, freezing of the plurality of dessert products within each of the plurality of dessert products within each of the plurality of baking cavities of the silicone molded baking tray after a partial baking of the dessert products and removing of the frozen dessert products from each of the baking cavities of the molded baking tray.

A further advantage of the present invention is that it provides for a flavored souffle dessert product that can be mass produced in an automated and economical manner and is readily affordable by the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A process for making a flavored souffle dessert product, comprising the steps of:
a) mixing and kneading of eggs, sugar, margarine/butter, flour, baking soda, salt and cocoa in a first mixing hopper to form a dough;
b) proofing said dough in a proofing refrigerator at a temperature between 35° and 45° F. for a time period of at least 24 hours;
c) stirring of a flavoring ingredient, corn syrup, vegetable oil, starch and water in a second mixing hopper to form a flavored paste filling;
d) gelling of said flavored paste filling in a refrigerator at a temperature of 50° F. for a time period of at least 12 hours;
e) encrusting an amount of dough about an amount of said flavored paste filling using an encrusting and extrusion machine to enclose said flavored paste filling;
f) extruding said encrusted dough and said enclosed flavored paste filling using said encrusting and extrusion machine for forming a flavored souffle dessert product and said dessert product having a weight in the range of 160 to 200 grams;
g) inserting said dessert products into a silicone molded baking tray having a plurality of cavities therein;
h) baking said dessert products within said plurality of cavities of said baking tray in an oven at a temperature of at least 350° F. for a time period of at least 30 minutes;
i) freezing said dessert products on a cooling rack within said plurality of cavities of said baking tray in a freezer unit at a temperature of at least −20° F. for a time period of at least 45 minutes;
j) removing said frozen dessert products from said plurality of cavities of said baking tray; and
k) placing said frozen dessert products in a shipping container for shipment to consumers.

2. A process in accordance with claim 1, wherein said flavored paste filling is selected from the group consisting of chocolate, vanilla, lemon, orange, lime, strawberry, raspberry, cherry, blueberry, custard, peach and apple compote and combinations thereof.

3. A process in accordance with Claim I, wherein said step e) of encrusting said amount of said dough is in the range of 120 grams to 140 grams.

4. A process in accordance with claim 1, wherein said step e) of encrusting said amount of said flavored paste filling is in the range of 40 grams to 80 grams.

5. A process in accordance with Claim 1, wherein the step i) of the freezing includes using a nitrogen freezing tunnel unit at a temperature between −40° F. and −50° F. for a time period of at least 15 minutes.

6. A process in accordance with claim 1, further including the step of rebaking said frozen dessert product in a convection-type oven at a temperature of at least 325° F. for a time period of at least 15 minutes.

7. A process in accordance with claim 1, further including the step of reheating said frozen dessert product in a conventional microwave oven on a high setting for a time period between 90 seconds and 180 seconds.
